(19) United States
(12) Patent Application Publication
(10) Pub. No.: US 2017/0116666 A1
(43) Pub. Date: Apr. 27, 2017

(54) SOCIAL INTERACTION ENABLING SYSTEM

(71) Applicant: Inspired Logic, Inc., Westlake Village, CA (US)

(72) Inventors: Ken Lawson, Westlake Village, CA (US); Andrew Markman, Thousand Oaks, CA (US)

(21) Appl. No.: 15/333,147

(22) Filed: Oct. 24, 2016

Related U.S. Application Data
(60) Provisional application No. 62/245,515, filed on Oct. 23, 2015.

(51) Int. Cl. G06Q 30/06; H04W 4/20; G06Q 20/06

(52) U.S. Cl. CPC G06Q 30/0641; G06Q 20/065; H04W 4/206; G06Q 50/01

(57) ABSTRACT

A social system is used to exchange virtual objects of value. The virtual objects may be associated with physical objects having real world value. The virtual objects may be used to encourage social behaviors or interactions among multiple users.

### PRIORITY

This application claims priority to U.S. Application No. 62/245,515, filed Oct. 23, 2015, which is incorporated by reference in its entirety into this application.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

In time past, a person had to rely on in person interactions to create new relationship. If a person was looking for a friend or companion, a person may go to a social establishment, such as a bar, or request an introduction from friends, or family. These personal exchanges permitted a person attempting to get another's attention different means to win affection that did not rely solely on the first physical appearance or impression to encourage continued exchanges. For example, the person may use wit, or gestures to win a person's attention.

Recently, creating social encounters has evolved and now encompasses the virtual world. Dating sites are used in many instances to encourage matches between different people of particular interests. Some sites will match individuals based on different characteristics, such as, ethnicity, income, academic history, social network, job, age, sexual orientation, gender, geographic location, among others. In these cases, a potential match based on one or more criteria may be presented to a user by showing a profile picture and/or providing a description of attributes of a potential match. If desirable, the user may indicate their desire to advance a discussion or introduction with the other user. That other user would typically then receive a message indicating the interest of the first user and provide a profile picture and/or other user details for the second recipient user to indicate their acceptance. The receiving user may then select to continue engagement and initiate a message/chat, or other meeting, or may reject or ignore the engagement and select another. Presently, only approximately 20% of confirmed matches (those in which both parties have indicated a desire to initiate discussions) actually proceed to further discussion or engagement by the receiving user. Even before the mutual match or acceptance, only approximately 7% of initiate requests to be match receive a mutual match or confirmation to proceed.

Unfortunately, the virtual engagement and especially the initial introduction/interaction is very limited to a static virtual image and/or user description that is provided with a given profile. Even when engagement is initiated by one side, at best the requesting user can generally only send a short written message. Such introduction limits the sender in showing an attribute of himself in a dynamic and charismatic way that was available when personal interactions were the normal means of introduction. Unfortunately, such engagements are focused on the appearance of the user and not on another attribute that may be more desirable in the individual. The virtual introduction, however, lacks any possibility of making an impression beyond the static profile picture and associated details.

### SUMMARY

Exemplary embodiments include an internet-based community such as a mobile application or website where users come together to meet, socialize, flirt, and date via a dynamic digital platform. Exemplary embodiments may streamline and enhance the romantic courting process. Exemplary embodiments permit a variety of courting behaviors and techniques not previously available to the virtual exchange.

Exemplary embodiments permit users to browse, in real-time, a live directory of people available to meet. This directory can be categorized by sexual orientation (M4W, W4M, M4M, W4W) and proximity to the user. Users can search for chat sessions, as well as receive chat requests. Other criteria may also be entered and/or used for providing an initial selection or matching of potential social partners. For example, gender, sexual orientation, age, geographic area, nationality, profession, income, school, social network, or a common attribute may be used to provide initial matchings or suggestions to a user for consideration.

In an exemplary embodiment, cam-to-cam video between users is available. In this case, the application may digitize a real world “pick-up” interaction. Therefore, like at a bar or club, a user may see the girl or guy you want to flirt with—no hiding behind text. Although your private information can remain anonymous (name, age, etc.), your face may not in an exemplary embodiment. In exemplary embodiments, users may have the ability to hide their thumbnail preview while on the hunt, and can ultimately choose an anonymous introduction or pick up, such as in a “blind date” interaction. In this case, an anonymous introduction may use a few choice words or, other behavior as explained in more detail herein to initiate an interaction.

Unlike other virtual dating interactions, exemplary embodiments described herein may provide other options besides a user's appearance or static profile information to make an impression. In an exemplary embodiment, the system uses an e-currency icon that can enable users to entice other users to socialize. For example, let's say you come across a girl that you want to meet, and she's currently engaged in a chat session with eight people. You might first join that chat and try to win her over with a few clever comments. But, if that doesn't work, you might offer to “buy her a drink.” This drink may be an e-currency icon that might cost the guy $5. These e-currency icons can be given conditionally or unconditionally. So, if she accepts, the two of you go into a private chat for as long as you mutually desire (although a minimum time may be required as part of the conditional gift), just like at a bar. She will be motivated to do this because the received e-currency may be used in different ways, such as re-gifted as the same or another e-currency icon to the same or another user, can be redeemed for real merchandise (electronics, cloths, purses, etc.), etc. These e-currency icons can simulate real world gifts that are used in the courting process (i.e. coffee, cocktail, bracelet, necklace, ring, dog, car, perfume, purse, iPad, etc.). In an exemplary embodiment, the value of a gift may be indicated by a corresponding apparent value in the icon representing the e-currency. For example, the more expensive the item costs in real life, the more expensive the e-currency icon may be displayed in the system, and the more value it may be worth to the recipient. Exemplary embodiments, may permit greater requirements be attached to gifts of greater value.

Like the real world, users may have the option to either hide or reveal their materialistic possessions (e-currency icons). If a guy wants to show off that he possesses an extremely desirable e-currency icon that every girl is after, maybe a diamond necklace, he can choose to un-hide his virtual wallet to attract attention. Or, he may hide his virtual wallet and choose to rely on his charm and good looks to initiate an exchange.

Exemplary embodiments may be used to permit people to compartmentalize their relationships online, or have them lead to real life encounters, if they so choose. In that breath, the system's feature set may make it possible to conduct a completely virtual relationship. Users may engage in virtual meet and greets, meals together, watching movies together, exercise together, etc. The system may also permit video chats, voice mail, e-mail, text chats, audio chats, and other virtual exchanges.

### DRAWINGS

FIGS. 1-13 illustrate exemplary user interfaces according to embodiments of the invention.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described here may include an internet-based mobile application or website community where users come together to meet, socialize, flirt, and date via a dynamic digital platform. Exemplary embodiments may streamline and enhance the romantic courting process by simulating “real world” courting behaviors and techniques in a “virtual” application.

Although embodiments of the invention may be described and illustrated herein in terms of a social site to initiate a romantic attraction or to fine a companion, it should be understood that embodiments of this invention are not so limited, but are additionally applicable to other social or virtual exchanges such as other social media, social chat programs, text, sims, e-mail, etc. Furthermore, although embodiments of the invention may be described and illustrated herein in terms of a combination of features and attributes to define an entire social platform, it should be understood that any combination of features may be combined to create any desired virtual exchange. Specifically, any function described herein may be used alone or in conjunction with other features. For example, exemplary embodiments may include the use of the e-currency icon functionality in other virtual exchanges such as chat, text, e-mail, etc. to provide value or currency from contacts, friends, and family. For another example, the user interface feature of making a selection, such as for an e-currency icon, and sending it to another user by dragging and dropping the associated icon on an individual's profile name, image, or other attribute may be used in other contexts outside of the social dating platform or to gift or send other objects.

Exemplary embodiments include an internet-based mobile application or website community where users come together to meet, socialize, flirt, and date via a dynamic digital platform. An exemplary system comprises a networked database that stores profile information from a plurality of users. Profile information may include a user's name, address, e-mail, phone number, gender, sexual orientation, age, or other factor desirable to matching or providing information in a social introduction. The system comprises a matching component configured to identify a subset of users from the plurality of users that meet one or more matching criteria associated with a specific user. The system is configured to present the subset of users to the specific user for consideration for continuing or attempting a social introduction.

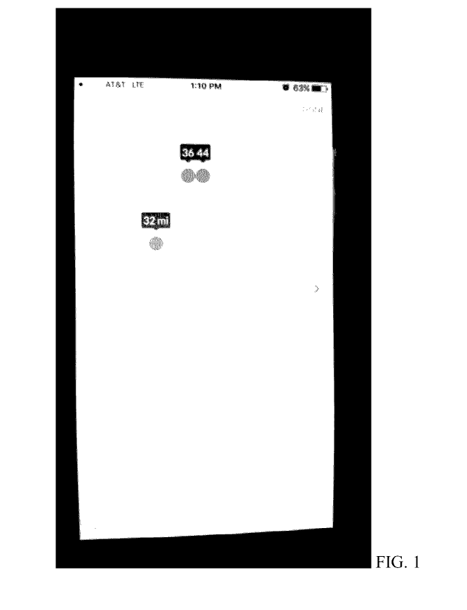

FIG. 1 illustrates a first user interface in which a specific user may select matching criteria. As shown, an age range, distance, and gender may be selected. Other matching criteria may be used, such as level of education, job, income, hobbies, pets, marital preference, marital history, children, nationality, religion, commonality in social network or prior activity, relationships, locations, etc., other profile attributes, and any combination thereof. The selection may be made by drop down, slide bar, text entry, radio button or check box selection, or other user input method.

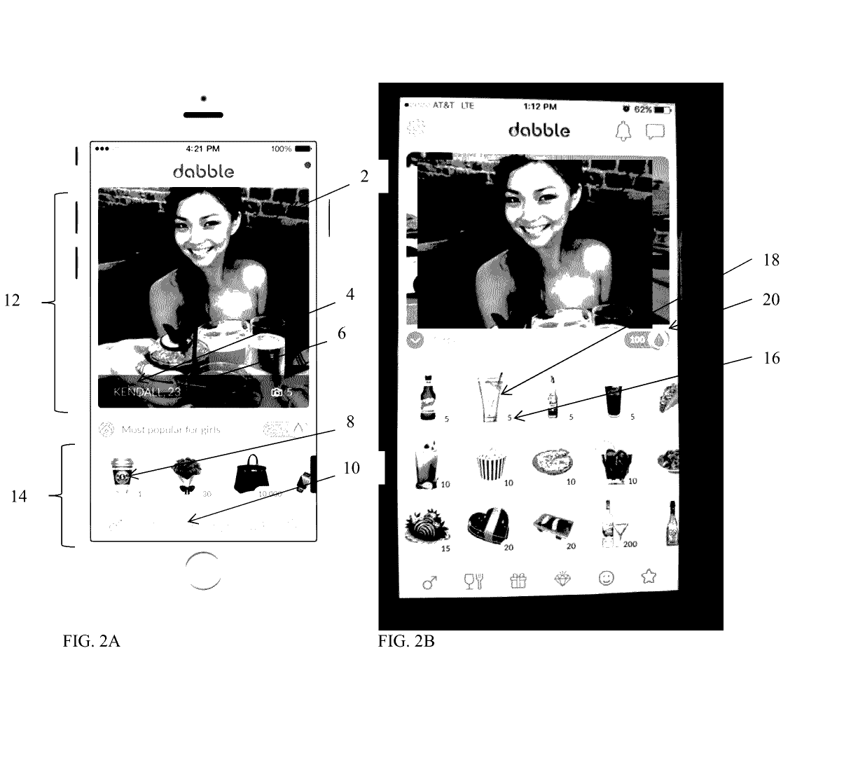

FIG. 2 illustrates an exemplary user interface in which a match is presented to a specific user as a possible recipient of attention by the specific user. The exemplary user interface may display a profile image 2, name 4, age 6, and/or other user profile information. The user may see more information by selecting the profile picture or name or otherwise providing a user input to obtain more information. The user may dismiss a possible match by providing a negative user input. The negative user input may be any user input received by the system to indicate the desire to pass or not engage the displayed candidate based on the presented user profile. For example, the user may select an “x” or other close window indicator through a touch screen or by manipulating a mouse on a computer screen. The user may alternatively or also swipe by dragging a touch or a click of the mouse in a predetermined direction such as from right to left. Conversely, the user may indicate a desire to proceed with an introduction by providing a positive user input. A positive user input may be a click or touch on part of the user profile, such as the user image or name, indicating a gift or e-currency icon to give to the recipient as described herein, by opening a text interface and typing in a message, swiping in a converse or different direction as used for a negative user input, etc. Any combination of negative and positive user inputs may be used to proceed or discard with an introduction.

In an exemplary embodiment, a user may send a candidate of interest (another user) an e-currency icon along or in conjunction with a picture, text, audio, or video message. For example, as shown in FIG. 2A. The user interface, in an exemplary embodiment, includes a target companion section 12 in which a target's profile details may be displayed as described herein. The user interface, may also include an available gifting section 14 that displays available e-currency icons available for gifting. The displayed e-currency icons may be any available icon that a user can purchase or one or more e-currency icons available to the user because they have already purchased the use of the e-currency item or has sufficient currency associated with the user to purchase the e-currency icon. The display may therefore display all options supported by the system, a subset of options based on one or more criteria of the user or system, the available options based on a pre-purchase or available currency of the user, or other display selection of icons. As shown, the available gifting section 14 may include one or more actual e-currency icons 8 to select or may show a grouping or categorization of icons 10. Therefore, the system permits a user to easily navigate through available e-currency icons to select the one appropriate or desired for a given target user. As shown in FIG. 2B, the e-currency section 14 may be expanded by dragging the section boarder upwards, or by providing another expansion indicator to the system. For example, the user may select an arrow or boarder, select the e-currency section, or otherwise expand the view of the available e-currency icons for selection.

As shown, the e-currency icon may display an image of the object it is intended to represent 18 and/or may display an associated value of the object 16. The displayed value may depend on the accounting backend or other system configurations as described more fully herein. In an exemplary embodiment, the user interface may also provide an available balance 20 indicating an amount or value available for purchasing e-currency icon(s).

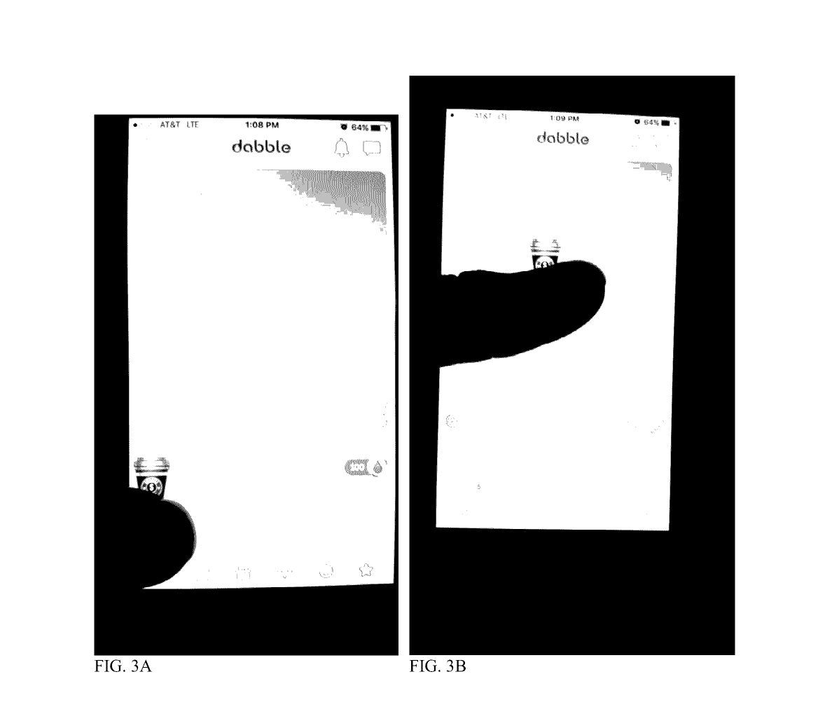

FIGS. 3A and 3B illustrate an exemplary progression of a user interface for an exemplary embodiment of making an e-currency icon selection and gift to another user. As shown, a user may select a desired e-currency icon by navigating the groupings and pressing a desired icon. The user interface may dim or otherwise de-emphasize the rest of the screen, while increasing a size, color, or otherwise indicating that an icon selection has been made. Because the user may be interacting on a touch screen, the user may not see the select icon when pressed. Therefore, in an exemplary embodiment, the icon may move to another portion of the screen or be duplicated such that a user can see and confirm that the selected icon was the one desired. The user may then drag and drop the icon to the recipient user to indicate the desire to gift the e-currency icon to the specific user. As shown, once an icon is selected, the screen may indicate one or more areas in which to deposit the icon in order to gift it to a specific user.

In an exemplary embodiment, the drag and drop gifting of an e-currency icon may be used with any user interface in any digital exchange. Accordingly, in an exemplary embodiment, the target companion section 12 of FIGS. 2A-2B, may be a contacts list, friends/family list from a social platform or mobile device contacts list, text list, chat list, etc. In an exemplary embodiment, this section may be a list of text recipients or contacts. The user may then select an e-currency icon and drag it to a recipient within a list of multiple possible recipients in order to gift the e-currency icon to another user.

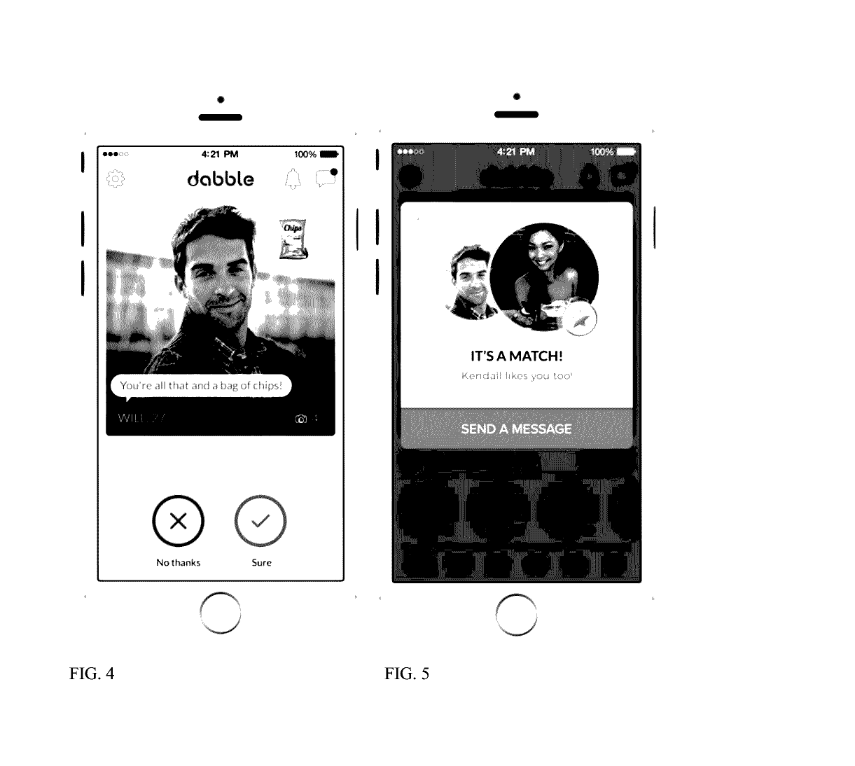

FIG. 4 illustrates a user interface of a recipient user of a gift. As shown, the recipient may receive a message indicating that an e-currency has been sent. The message may simply indicate the receipt of an e-currency icon or may additionally provide a text, audio, video, or other attached message and/or profile information associated with the sender. As shown, the user interface may permit the recipient to accept or reject the e-currency icon and/or dismiss or initiate a social interaction with the sending user. If the user rejects the gift, then a message may be sent to the sender. The sender and recipient may thereafter continue to search for potential relationships and/or send other gifts and messages according to embodiments described herein. If the recipient accepts the gift, then confirmation may be sent to the sender, such as illustrated in FIG. 5.

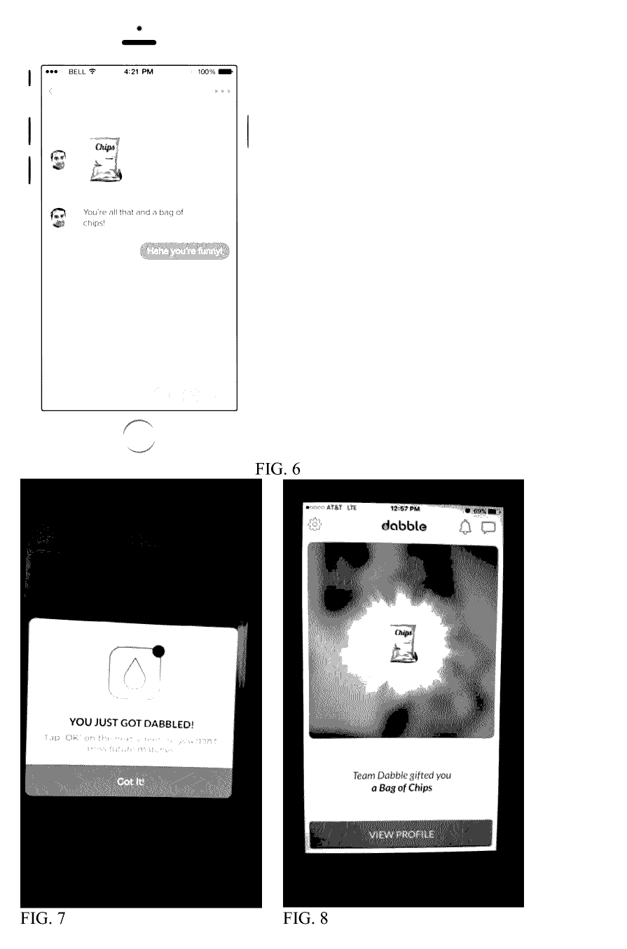

After accepting an e-currency icon, a text or other virtual social exchange may be initiated. For example, as illustrated in FIG. 6 a text chat may commence after acceptance. The virtual social exchange may track a history, and include an indication of the receipt or sending of the e-currency icon.

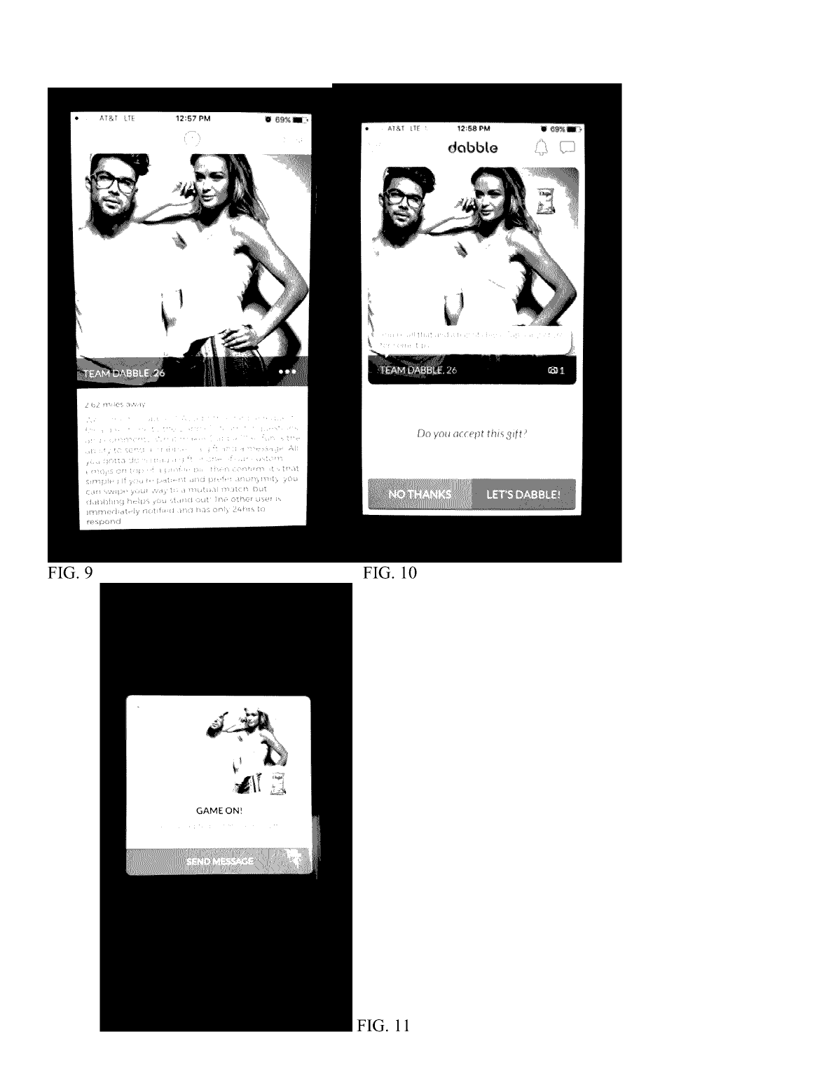

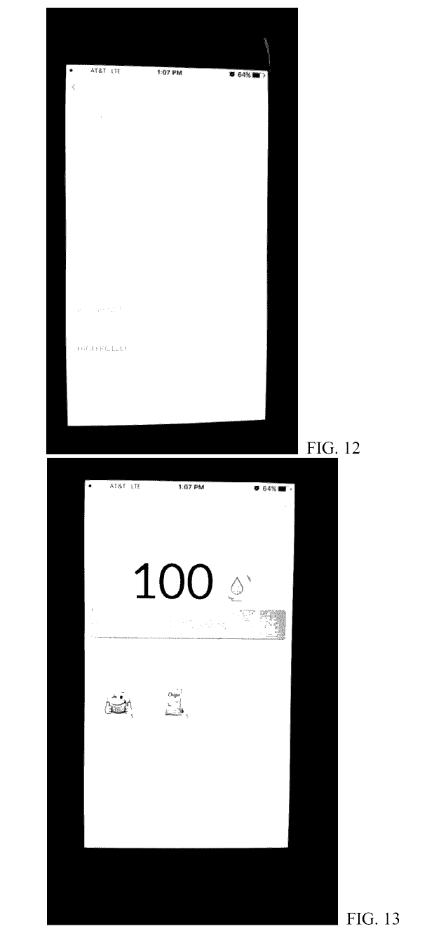

Exemplary embodiments may occur within the social networking platform or outside of the platform. In an exemplary embodiment, a user may send an e-currency icon to another user. As illustrated in FIG. 7, a pop-up window may be shown on a user's device to indicate that they have received an e-currency icon. As shown in FIG. 8, the user may then indicate a desire to see the e-currency icon and/or information about the sender. Information about the sender may be shown to the user, such as illustrated in FIG. 9. As shown in FIG. 10, the recipient may then accept or reject the gift. After a selection, as illustrated in FIG. 11, the recipient and/or sender may receive a confirmation message and/or indicate a desire to continue a virtual exchange. The social exchange may be through an introduction and social networking site as described herein, or may be through any platform or standalone application.

The e-currency icon can be handled in a number of exemplary ways. For example, the e-currency icon may indicate an associate set of points, value, or currency that may be re-gifted as another e-currency icon of the same or lesser value or redeemed for products, currency, discounts, gift-cards, etc. For another example, the e-currency icon may be associated with the actual object for which its icon represents. For another example, the e-currency icon may be a redeemable coupon or payment type redeemable at a point of sale. Any combination of e-currency icons may be used.

In an exemplary embodiment, the e-currency icon may indicate an associate set of points, value, or currency that may be regifted as another e-currency icon of the same or lesser value or redeemed for products, currency, discounts, gift-cards, etc. In this case, a person may purchase a set of points for a dollar amount. As illustrated in FIG. 12, points may be associated with a virtual currency such as a gold coin. Different quantities of the virtual denomination may then be purchased for different amounts. Then, as illustrated in FIG. 2B, the available virtual currency may be displayed to a user in order to select an e-currency icon within their budget. The system may therefore support a virtual wallet configuration in which available virtual currency may be used to purchase e-currency icons or virtual items for another user and sent to initiate a virtual social exchange.

In an exemplary embodiment, the received e-currency icon may be associated with the purchase points and used by the recipient. In this case, the recipient may receive the e-currency icon and know the object intended to be purchased. Therefore, a witty statement or introduction may correspond to a specific gift. For example, a user may send a bag of chips with the line, “you are all that and a bag of chips.” However, the recipient may receive the value of the e-currency icon in their virtual wallet. In this case, the recipient may then use the associated value of the e-currency icon. For example, the recipient may similarly have an account of coins and the quantity may be increased based on the coins associated with the received e-currency icon.

In an exemplary embodiment, the received e-currency icon may be associated with a secondary object of value. In this case, the sending and receiving of e-currency icons may earn a user other system revenue. In an exemplary embodiment, this configuration may be used to facilitate or encourage a gaming type atmosphere. For example, the system may be configured to encourage different user actions. Therefore, a user may earn rewards for certain actions. In an exemplary embodiment, a user may earn karma be performing actions promoted by the system. The amount of karma earned by a user may depend on the value of the action. For example, a user may be encouraged to initiate conversations within a social networking platform. Therefore, as a user fills out a profile to be found by others, the user may earn karma. A user may also earn karma in the same or different quantities, such as by initiating conversations, indicating a desire to chat with another user, accepting a chat from another user, or making other social introductions. In an exemplary embodiment, a user may earn karma for sending, receiving, and accepting e-currency icons. The amount of karma may be proportional to, related to, or determined by an associated value of the e-currency icon. Therefore, a user that sends and/or receives more expensive e-currency icons may earn more karma. Karma may then be used or redeemed in any number of ways as described herein. For example, once a user reaches a pre-determined karma level, the user may redeem their karma for physical objects, prizes, virtual currency such as to purchase or re-gift e-currency icons, gift cards, discounts, coupons, etc. The secondary object of value, such as karma, may also improve the user's interaction with the system. For example, the number or diversity of e-currency icons available to gift may be related to the secondary object of value. The greater a user's karma, the more e-currency icons the user may be able to select from. The greater a user's karma, the better placement or priority a user may get in other user's search results. Therefore, an e-currency icon may represent a first item of value and when sent and received by create, define, or otherwise affect a second object or value. Social behavior may also be curbed by immediate response actions, such as receipts of gifts, e-currency icon, virtual currency, etc.

In an exemplary embodiment, the e-currency icon may be associated with the actual object for which its icon represents. In this case, the system may order and/or send a physical object represented by the e-currency icon to the recipient. The system may use profile details, such as address and other contact details and preferences to send physical objects to a recipient. In this case, the e-currency icon may be associated with a virtual store such that a selection of a physical object may be provided through any delivery mechanism to the recipient.

In an exemplary embodiment, the e-currency icon may be a redeemable coupon or payment type redeemable at a point of sale. For example, the recipient may receive a coupon that can be printed or redeemed electronically through a virtual or physical marketplace. In the case of chips, the recipient may receive a coupon that is redeemed for a bag of chips at a grocery store or other convenience store. The recipient may print the coupon or display a virtual interface at the point of sale to redeem for the associated item. In an exemplary embodiment, a virtual currency may be provided such that an actual value for the purchased product may be charged to the sender once a purchase has been made.

In an exemplary embodiment, the redemption of an e-currency icon may be associated with a physical location. For example, the system may match people according to a physical geographic proximity. If the geographic proximity is within a certain store, restaurant, bar, or social area, a user may be presented with a selection of e-currency icons associated with an establishment within the area or in which the user is present. For example, if a user is at a coffee shop, the user may select to send another user a cup of coffee. The recipient, if within the geographic proximity of the coffee shop, may receive a coupon, discount, currency, or other redeemable item for an immediate cup of coffee at a specific establishment. Therefore, a user may use the social network for buying a beverage for another patron at the same establishment. Alternatively, the sender may be anywhere, and a specific establishment may be associated based on the recipient's location. In this case, a sender may wish to buy another user a cup of coffee. Regardless of where the sender is, the recipient may receive a method to redeem the e-currency icon for a cup of coffee at a specific establishment that may be dictated by the geographic proximity of the recipient to one or more establishments.

In an exemplary embodiment, the availability of an e-currency icon may be associated with past or present physical location from either the sender or receiver. For example, when a user is within an establishment or within a geographic location, the available e-currency icons may be presented associated with that geographic location. If, for example, a user is at a certain restaurant, the user may be presented with certain cocktail options or appetizers that may be gifted. The e-currency icon may also be more generally related to the establishment itself, such the coffee icon becomes a Starbucks® icon. The available e-currency icons may depend on the present and/or past location of either the sender or recipient.

Accordingly, in an exemplary embodiment, the system may be configured to engage specific corporate sponsorship by associating an e-currency icon in a virtual exchange to a physical equivalent in the real world. In exemplary embodiments, the e-currency icon relationship to a physical equivalent may be based on the geographic location of the sender, the geographic location of the recipient, the proximity of the sender and/or recipient to a physical location, the corporate support or sponsorship of the system, the value of the e-currency icon, among other attributes, and any combination thereof.

In an exemplary embodiment, the value associated with an e-currency icon may be virtual, perceived, sentimental, economic, physical, or combinations thereof. For example, exemplary embodiments may permit a user to simply purchase e-currency icons of a specific object that may be gifted to another individual. The recipient may keep the e-currency icons as simply a virtual present that may be retrieved and observed as the recipient desires. The e-currency icon may simply be a virtual gift to accompany the initiate request to match or to initiate a conversation to act as an introduction ice breaker. Therefore, exemplary embodiments may limit or exclude redemption options or values for recipients or include them.

The system according to an exemplary embodiment may therefore comprise a networked server that permits communication between remote and/or mobile devices. The system may be configured to store in a database user profiles, preferences, and other data. The system may be configured to retrieve geographic location from a user's remote device and make suggestions or potential matches based on user attributes, geographic locations, and any combination of criteria. The system may be configured to display one or more user interfaces to a user to permit social interactions between users.

The system may be configured to permit a user to gift a virtual object having value to other users to facilitate a social exchange, or for other purposes. The virtual object may comprise an e-currency icon that resembles a physical object that has value, a physical object, a hypothetic object, a metaphoric object, or any combination thereof. The virtual object may be associated with a virtual value related to the value of the physical object. Therefore, within a plurality of e-currency icons, a specific e-currency icon may have a higher or lower virtual value in proportion or relative to the value of the associated physical object represented thereby. Exemplary embodiments of the system may be configured to permit a user to gift the e-currency icon to other users. The e-currency icons may be based on a point system or may have other associated value. The e-currency icon may be redeemed for actual physical objects or cash value or may be used in other exchanges such as to re-gift e-currency icons, coupons, discounts, promotional incentives, etc. The e-currency icon may also be configured or related to a second level of value system to encourage certain behavior or action. In this case, a user may accumulate currency of the second level value system by performing certain virtual actions within the system. The user may accumulate currency of the second level value system by exchanging the e-currency icons. The value increase of the second level value system may relate to the value of the e-currency icon, such that a greater increase of the second level value system may accompany the exchange (either gift and/or receipt) of an e-currency icon of greater value.

Exemplary embodiments, may relate an e-currency icon to physical value. In an exemplary embodiment, the relationship to the e-currency icon value and physical value may be dynamic. For example, the e-currency icon value may depend on the intended recipient of the e-currency icon. If the recipient is receiving a lot of social attention, then the physical value associated with the e-currency icon may increase, such that sender can have to pay more for sending an e-currency icon to a recipient of high traffic or a lot of social attention.

The system in exemplary embodiments may provide additional social indicators to the sender of a social invitation. For example, a social indicator may be provided or associated with users such that a sender may have an indication of the inclination of a user to respond to a request, social invitation, or gift. Social indicators may include statistics about a user's response behavior, such as how long a chat or interaction is engaged after receipt of a gift, how many responses or proportion of responses to invitations are accepted, how many e-currency icons the user has been gifts, etc.

The system in exemplary embodiments may also associate system requirements or limitations on the exchange of e-currency icons. For example, if an e-currency icon is sent and/or accepted by a user, the recipient may be required to initiate a virtual exchange with a user. The exchange may be required for a period of time or a number of exchanges. The requirements for the exchange may also depend on the value of the e-currency icon. For example, if a high value e-currency icon is gifted and accepted, the recipient may receive a voice call or video request verses simply initiating a textual chat request for lower value e-currency icon exchanges.

The system in exemplary embodiments may also be configured to support a number of different virtual social exchanges. These exchanges may be anonymous. For example, the system may permit users to call one another without providing any personal or contact information during the exchange. Different virtual social exchanges may include, but are not limited to, video chat, text chat, audio calls, group chats, limited/private chats, pictures, etc.

In an exemplary embodiment, users will be able to hunt for flirt sessions, as well as receive flirt requests. An intuitive thumbnail “line up” interface may be used to facilitate initial selection of candidates, providing users with a steady stream of targeted profiles to cycle through.

Existing mobile dating apps have done a great job proofing the concept of a game like dating interface. However, they fail in providing a user the ability to differentiate him or herself like they can in real life. The current social platforms and dating applications in this space force a user to rely on profile pictures to entice potential matches. Using exemplary embodiments described herein, users may differentiate themselves through any combination of the following:
Users may have the ability to private message another person. This could help a user win over a possible flirt partner through a few choice words. Users may also be able to send other social communications such as text, written, picture, video, audio, call requests, video requests, etc.
Users may have the ability to purchase profile badges (background checks) that can make them more desirable to potential flirters.
Users may have the ability to make themselves more appealing through the acquisition and sharing of property. For example, users may be able purchase virtual properties that mimic real life material objects or provide other value to a recipient.
Users may have the ability to add short videos to their profiles, not just static pictures.

These elements may be used to level the social playing field and make it all about your flirt “game,” instead of all about your profile picture.

Exemplary embodiments may comprise a stand-alone application, not requiring Facebook authentication. Although, exemplary embodiments may use an option to join via Facebook, users that wish to not comingle their profiles will have the ability to create a stand-alone login.

Exemplary embodiments may be used to implement a paradigm shattering icon currency (“e-currency icon”). It may enable users to entice other users to flirt. For example, a user may come across a girl that they want to flirt with. The user might first try to win her over with a few clever comments. But, if that doesn't work, the user might offer to “buy her a drink.” This drink is a “e-currency icon” that might cost the guy $5 and is worth 5000 points to the girl.

An exemplary embodiment may therefore be used to streamline and virtualize a real world social transaction, just like at a bar, club or party. Women will be motivated to do this because their points can be redeemed for real merchandise (electronics, clothes, purses, etc.). This redemption may be for physical goods, gift cards, store credits, crypto-currency, or other, valuable currencies or pseudo-currencies. These e-currency icons will simulate real world gifts that are used in the courting process (i.e. coffee, cocktail, bracelet, necklace, ring, dog, car, perfume, purse, iPad, etc.). Exemplary embodiments may also incorporate product placement opportunities by corporate sponsors.

Once the application reaches the critical mass necessary to demand it, imagine the coveted Lamborghini Hurricane e-currency icon or a Cartier watch e-currency icon. The more expensive the item costs in real life, the more expensive the e-currency icon may be on the application, and the more points it may be worth to the recipient.

The real-world counterparts to these icons may be sponsored by the owner of a respective brand. For example, Starbucks® (or another retailer) may enable a user to purchase an e-currency icon associated with an in-store coffee. Once an individual obtains that e-currency icon, it may be traded in for store credit, a physical coffee, a Starbucks gift card or Starbucks app credit. Similarly, Starbucks may pay a fee in order to have its e-currency icons appear in exemplary embodiments available e-currency icons. Further, rather than exchanging the e-currency icons, Starbucks may cover the cost associated with the e-currency icon because it is a “sponsored” icon for the giver in order to encourage recipients to visit Starbucks (or other retail) locations.

The in-app sponsored product and brand placement provides brand owners (advertisers) with a new medium to interact with their customers. The associated advertising platform can give advertisers information on the number of user interactions, such as user purchases, user trades, user gifts, and user redemption of products in the e-currency icons bearing or related to a particular brand. In this way, the advertising platform is able to give their advertisers statistics on how many times people have digitally come in contact, thumb to screen, with avatars of their merchandise and brands.

The purchase, sale, trade and redemption of e-currency icons that are purchased with real world money, traded within the app as currency, and ultimately redeemable back into real world currency, crypto currency (Bitcoin), gift cards, or merchandise may encourage interactions, both between people and between people and brands that may not have occurred otherwise.

Like the real world, users will have the option to either hide or reveal their materialistic possessions (e-currency icons). If a guy wants to show off that he possesses an extremely desirable e-currency icon that every girl is after, maybe a diamond necklace, he can choose to un-hide his virtual wallet. Or, if he wants a girl to like him for who he is, he may choose to rely on his charm and good looks, and therefore, hide his virtual wallet.

In addition, the act of taking, obtaining, sending, or receiving an e-currency icon may use drag and drop functionality such that selecting an e-currency icon from a drawer or menu of e-currency icons and dragging the selection from the drawer to another user's face, user icon, or other identification of a specific user may cause the exchange of the e-currency icon to take place. Similarly, purchasing or obtaining an e-currency icon may rely upon drag and drop functionality such that e-currency icons may be purchased or obtained by selecting an e-currency icon within an e-currency icon store and dragging it or moving it from the store to a user's repository. Similarly, a user may indicate a request for a particular e-currency icon by dragging and dropping in a similar manner which may then communicate, using the app, to another user of the app that a particular user wishes to obtain the identified e-currency icon. This functionality may only be available in situations in which a user has elected to make his or her e-currency icons visible to other users.

We expect the most attractive users to get a disproportional amount of inbound flirt requests. For example, the most attractive users may receive many more flirt requests than an average user. Because those providing e-currency icons wish to actually obtain the attention of those attractive users, it may create a situation in which gifts are given but the receiving user is unable to timely respond to all of the incoming flirt requests. To curb this, an escalating multiplier technology may be used that will automatically raise the price of e-currency icons sent to a high-traffic user when that user is experiencing high traffic periods. For example, it may cost a sender 2× the normal amount, per e-currency icon, to gift someone who is currently receiving attention from many users of the platform. This will reduce the number of incoming requests and ensure that those who make gifts are serious about flirting because the e-currency icons will cost them more money.

Exemplary embodiments may attempt to enable users to make educated decisions when gifting, via our Social Indicator (response rate percentage). When browsing profiles, a potential suitor may be able to view this indicator before gifting and/or initiating a flirt. For example, a guy might be more hesitant to gift an expensive item to a girl whose social indicator is only 30%. This means she only corresponds with 30% of the guys she accepts gifts from. A user whose social indicator is closer to 90% is more likely to receive another individual's attention. Other statistics may also be provided, depending upon the implementation. For example, average length of “flirt” sessions may be provided so that users with high social indicators, but low average flirt session length (e.g. 30 seconds) will be disfavored. These and other statistics may be provided in conjunction with a user profile or incorporated as a part of the process of e-currency icon giving.

Integration with other social platforms (i.e. Facebook®) may enable users to identify friends that are on the platform, and friends of friends that might be in proximity or within a geographic location. This could be the perfect “ice breaker” for sparking up a flirt session or can be used as a filter to ensure you don't end up flirting with someone you know. Mutual friends are a big factor in establishing affinity with another human being, or may be the very thing you're looking to avoid.

Exemplary embodiments may be used to improve social responses in the social networking environment. Exemplary embodiments have been shown to improve the changes of proceeding to a conversation after a mutual match to approximately 60 percent, almost three times improvement. Exemplary embodiments have been shown to improve the changes of receiving a confirmation match to a request to match to 14%, almost double the chances of making an initial match.

Exemplary embodiments may give the world the ability to conduct a romantic relationship online, or use the experience to create real life encounters. In an exemplary embodiment, the system may support evolving feature sets that may make it possible to conduct a completely virtual relationship. For example, users may be able to engage in virtual meet and greets, meals together, watching movies together, exercise together (iOS Health, fit bit), etc. The system may therefore be part dating, part game, part sim, part messenger, and part video chat.

An exemplary embodiment may include any combination of the follow features:
Free to join
Real-time thumbnail preview homepage
Strict no nudity public chat policy
Anything goes between consenting adults in private chat
Possible membership fee or point qualification to access private chat
Users can view other users within a public chat and engage if desired
Facebook/Twitter/Pinterest sharing integration
Possible rating and/or “Like” functionality for users
Solid mobile app for front facing camera smartphones
Private gifting without revealing address or restricted personal information
Strict privacy, no activity logs, no selling of user data, no recording through the platform
Possible date/travel packages for virtual and real world encounters
Social game play (chess, Scrabble, etc.)
Watch movies and TV shows together

Exemplary embodiments described herein are in terms of e-currency icons. These icons may be any representation of objects that may have a perceived value to a user, either sender or recipient. The value is not limited to economic only, but may include sentimental value as well. In an exemplary embodiment, the icon represents a real world equivalent object. For example, the icon may be a gift card, cash, drink, coffee, necklace, car, moon, stars, etc. The icon may represent an associate physical object for which the user may receive, or merely a metaphoric representation to be used to initiate a social exchange. The e-currency icon may therefore be an avatar or selectable icon to be used by the user for different purposes. The exemplary embodiments described herein are not intended to be limiting, and can be used in any combination.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The term “comprising” in intended to be synonymous with “including” and does not mean “consisting only of”. Reference to any prior art in the description should not be taken as an indication that the prior art forms part of the common general knowledge. Moreover, any cited reference is incorporated herein by reference in its entirety.

The invention claimed is:

1. A system, comprising:
a network server that permits communication between a plurality of mobile devices;
a database storing a plurality of user profile information;
non-transitory, executable code that when executed by a processor performs the function of:
identifying and presenting a plurality of possible matches to a user through a user interface;
receiving a user input for each of the plurality of possible matches indicating a desire to proceed with a match or to decline the match with the possible match;
receiving a user selection of an e-currency icon to send to at least one of the possible matches indicated with a desire to proceed;
sending the e-currency icon to the at least one of the possible matches;
receiving a second input from the at least one of the possible matches indicating a desire to proceed;
initiating a chat between the user and the at least one of the possible matches.

2. The system of claim 1, wherein the non-transitory, executable code is configured to perform the additional functions of: receiving payment from the user to purchase the e-currency icon.

3. The system of claim 2, wherein the non-transitory, executable code is configured to permit the at least one of the possible matches to redeem a value associated with the e-currency icon.
